(19) United States
(12) Patent Application Publication
(10) Pub. No.: US 2011/0148744 A1
(43) Pub. Date: Jun. 23, 2011

(54) PLASMA DISPLAY PANEL

(76) Inventors: Yusuke Fukui, Osaka (JP); Masahiro Sakai, Kyoto (JP); Mikihiko Nishitani, Nara (JP); Yosuke Honda, Osaka (JP); Michiko Okafuji, Osaka (JP); Yasuhiro Yamauchi, Osaka (JP)

(21) Appl. No.: 12/934,609

(22) PCT Filed: Jan. 13, 2010
(86) PCT No.: PCT/JP2010/000139

§ 371 Date: Dec. 1, 2010

(30) Foreign Application Priority Data
Feb. 18, 2009 (JP) 2009-035245

(51) Int. Cl. G09G 3/28

(52) U.S. Cl. 345/60

(57) ABSTRACT

A first aim of the present invention is to provide a PDP capable of stably delivering favorable image display performance and being driven with low power, by improving the surface layer to improve secondary electron emission characteristics and charge retention characteristics. A second aim of the present invention is to provide a PDP capable of displaying high-definition images even when the PDP is driven at high speed by preventing the discharge delay during driving. In order to achieve these aims, the surface layer (protective film) 8 of a film thickness of approximately 1 μm is disposed on a surface of the dielectric layer 7 that faces a discharge space 15. The surface layer 8 includes CeO₂ as the main component and Ba, and a concentration of Ba in the surface layer 8 is in a range of 16 mol % to 29 mol % inclusive. With this structure, an electron level having a certain depth is introduced in a forbidden band in the surface layer 8, or an electron level of a valence band is elevated to narrow a band gap. An attempt is made to improve secondary electron emission characteristics and charge retention characteristics in this manner.

### TECHNICAL FIELD

The present invention relates to a plasma display panel that makes use of radiation caused by gas discharges, and in particular to technology for improving the characteristics of a surface layer (protective film) that faces a discharge space.

### BACKGROUND ART

Plasma display panels (hereinafter, referred to as “PDP”s) are flat display apparatuses that make use of radiation caused by gas discharges. PDPs can easily perform high-speed display and be large in size, and are widely used in fields such as video display apparatuses and public information display apparatuses. There are two types of PDPs, namely the direct current type (DC type) and alternating current type (AC type). In particular, surface discharge AC type PDPs have been commercialized due to having a great amount of technological potential in terms of lifetime and increases in size.

FIG. 6 is a schematic view showing a structure of discharge cells, or discharge units, of a general AC type PDP. The PDP 1x shown in FIG. 6 is constituted by a front panel 2 and a back panel 9 that are sealed together. The front panel 2 as a first substrate includes a front panel glass 3. A plurality of display electrode pairs 6, each composed of a scan electrode 5 and a sustain electrode 4, are disposed on one surface of the front panel glass 3. A dielectric layer 7 and a surface layer 8 are layered sequentially to cover the display electrode pairs 6. The scan electrode 5 and the sustain electrode 4 are respectively composed of transparent electrodes 51 and 41 and bus lines 52 and 42 layered thereon.

The dielectric layer 7 is made of low-melting glass with a softening point of approximately 550° C. to 600° C. and has a current limiting function that is peculiar to the AC type PDP.

The surface layer 8 protects the dielectric layer 7 and the display electrode pairs 6 from ion bombardment resulting from plasma discharge, efficiently emits secondary electrons in a discharge space 15 and lowers firing voltage of the PDP. Generally, the surface layer 8 is made, by the vacuum deposition method or the printing method, using magnesium oxide (MgO) that has high secondary electron emission characteristics, high sputtering resistance, and high optical transmittance. Note that, instead of the surface layer 8, a protective layer (also, referred to as a protective film) having the same structure as the surface layer 8 and exclusively for ensuring the secondary electron emission characteristics may be disposed.

On the other hand, the back panel 9 as a second substrate includes a back panel glass 10 and a plurality of data (address) electrodes 11, which are used for writing image data, disposed on the back panel grass 10 so as to intersect the display electrode pairs 6 at a right angle. On the back panel glass 10, a dielectric layer 12 made of low-melting glass is disposed to cover the data electrodes 11. Disposed on the dielectric layer 12, at the borders with the neighboring discharge cells (not illustrated), are barrier ribs 13 of a given height, made of low-melting glass. The barrier ribs 13 are composed of pattern parts 1231 and 1232 that are combined to form a grid pattern to partition a discharge space 15. Phosphor ink of either R, G, or B color is applied to the surface of the dielectric layer 12 and the lateral surfaces of the barrier ribs 13, and baked to form phosphor layers 14 (phosphor layers 14R, 14G, and 14B).

The front panel 2 and the back panel 9 are sealed together at opposing edge portions of both panels such that a longitudinal direction of the display electrode pairs 6 is orthogonal to a longitudinal direction of the data electrodes 11 with the discharge space 15 therebetween. The sealed discharge space 15 is filled with a rare gas such as Xe—Ne or Xe—He as a discharge gas, at a pressure of some tens of kPa. This concludes a description of the structure of the PDP 1x.

A gradation expression method (e.g. an intra-field time division gradation display method) that divides one field of an image into a plurality of subfields (S.F.) is used to display images in the PDP.

In recent years, electrical appliances are desired to be driven with low power, and the same desire exists for PDPs as well. In PDPs that display high definition images, discharge cells are made smaller in size and increased in number. Therefore, in order to surely produce write discharges, operating voltage is required to be increased in the small discharge spaces. The operating voltage of PDPs depends on a secondary electron emission coefficient (γ) of the surface layer. Here, γ is a value that depends on materials of the surface layer and discharge gases, and γ is known to increase as work functions of the materials decrease. Increased operating voltage becomes an obstacle to drive PDPs with low power.

In view of this, Patent Literature 1 discloses technology for constituting the surface layer having an amorphous structure in which cerium dioxide (CeO₂) is added to MgO such that the concentration of CeO₂ is in a range of 0.1 mol % to 20 mol %. Specifically, an attempt is made to suppress the increase in the operating voltage by constituting the surface layer made of amorphous MgO by adding CeO₂, and preventing the surface layer from being degraded (carbonized) by the reaction with impurity gases.

Patent Literature 2 also discloses the technology for constituting the surface layer having the amorphous structure in which CeO₂ is added to MgO such that the concentration of CeO₂ is in a range of 0.1 mol % to 20 mol %. With this structure, an attempt is made to reduce firing voltage and sustain voltage of PDPs.

Furthermore, Patent Literature 3 discloses a surface layer in which CeO₂ is added to MgO such that a weight ratio of CeO₂ is in a range of 0.011 to 0.5. With this structure, an attempt is made to reduce operating voltage.

In addition, Patent Literature 4 discloses a surface layer that includes SrO as the main component and CeO₂. With this structure, an attempt is made to stably cause a PDP to discharge at low voltage.

### CITATION LIST

### Patent Literature

### [Patent Literature 1]

Japanese Patent Application Publication No. 2000-164143

### [Patent Literature 2]

Japanese Patent Application Publication No. H11-339665

### [Patent Literature 3]

Japanese Patent Application Publication No. 2003-173738
[Patent Literature 4]

Japanese Patent Application Publication No. S52-116067

### SUMMARY OF INVENTION

### Technical Problems

It is difficult to say that, however, the above-mentioned conventional technologies fully achieve the goal of actually driving the PDPs with low power.

In addition, there is a production efficiency problem because an aging time required in the surface layer including CeO₂ becomes longer than that required in the surface layer including MgO.

Furthermore, a problem of “discharge delay” occurs in PDPs. Here, the “discharge delay” refers to a time lag that occurs between a rising edge in a voltage pulse and an actual discharge in a discharge cell during driving of the PDP. In the field of displays such as the PDPs, since information on image source has been increased as the PDPs have displayed high definition images, the number of scan electrodes (scan lines) on a display surface tends to be increased. A full-high-vision TV, for example, has more than twice as many scan lines as a conventional NTSC TV. In order to accurately display images in such a high definition PDP, the PDP needs to be driven at high speed as the information on image source has been increased. A sequence in a field is required to be driven at high speed, specifically, in 1/60 [s] or less.

For the high-speed drive, there is a method, for example, of narrowing down a width of pulses applied to the data electrodes in a write period of a sub-field.

However, driving the PDP at high speed by the above mentioned method will worsen the problem of the “discharge delay” will occur. As the pulse width is made narrower for the high-speed drive, the “discharge delay” is more likely to occur, because a chance that the discharge is completed in duration of the narrowed pulse is reduced. As a result, some cells are not lit (a lighting failure), and image display performance is compromised. In particular, in the PDP that has the surface layer of the amorphous structure as disclosed in Patent Literature 1, since initial electrons for suppressing the occurrence of the discharge delay are less likely to be emitted from the surface layer into a discharge space, degradation of image quality occurs more commonly due to the unlit cells.

As set forth above, there are still several problems to be solved in conventional PDPs.

The present invention has been achieved in view of the above problems. A first aim of the present invention is to provide a PDP capable of stably delivering favorable image display performance and being driven with low power, by improving the surface layer to improve secondary electron emission characteristics and charge retention characteristics.

A second aim of the present invention is to provide a PDP, in addition to having the above-mentioned effects, capable of stably delivering high image display performance in a case of displaying high-definition images at high speed, by preventing the occurrence of discharge delay during driving of the PDP.

### Solution to Problem

In order to achieve the above aims, one aspect of the present invention is a plasma display panel having a first substrate and a second substrate that oppose each other and are sealed together at opposing edge portions thereof so as to enclose a discharge space, the first substrate including a plurality of display electrode pairs, the discharge space being filled with a discharge gas, wherein the first substrate includes a surface layer at a side thereof facing the discharge space, the surface layer including CeO₂ as a main component and Ba, a concentration of Ba in the surface layer being in a range of 16 mol % to 31 mol % inclusive.

Here, it is more preferable that the concentration of Ba in the surface layer be in a range of 16 mol % to 24 mol % inclusive to prevent carbonate from adhering to the surface layer.

Furthermore, it is more preferable that the concentration of Ba in the surface layer be in a range of 26 mol % to 29 mol % inclusive to obtain an effect of reducing driving voltage.

Here, the surface layer may have a fluorite structure.

Here, the first substrate may include MgO particles disposed on the surface layer so as to face the discharge space. In other words, a surface layer as a whole may be constituted by including (i) the above-mentioned surface layer as a base layer and (ii) MgO particles disposed on the surface layer so as to face the discharge space.

The MgO particles can be produced by a gas phase oxidation method. Alternatively, the MgO particles can be produced by baking MgO precursors.

### Advantageous Effects of Invention

The PDP in the present invention having the above-mentioned structure is characterized by exhibiting high secondary electron emission characteristics in the surface layer including CeO₂ as the main component and Ba. The high secondary electron emission characteristics are considered to be exhibited for the following two reasons.

First, by adding Ba to the surface layer, an electron level of a valence band in the surface layer is introduced at a level 4 to 6 eV below the vacuum level. Compared to the surface layer composed of MgO that is currently in practical use (in the surface layer composed of MgO, an electron level of a valence band is at a level approximately 8 eV below the vacuum level), there are enough energies that are obtained in the Auger neutralization process in the surface layer including Ba. Therefore, since a large number of electrons are excited, the surface layer including Ba has significantly higher secondary electron emission characteristics. In general, the surface stability of BaO is so poor that BaO is easily hydroxylated and carbonized by being exposed to the air for a few seconds. Therefore, when PDPs that have the surface layers made of BaO are manufactured, these PDPs must be manufactured under extremely clean conditions. The surface layer of the present invention, however, includes CeO₂ having high chemical stability as the main component. As long as the surface layer of the present invention is manufactured under a condition that is clean to some extent, it is possible to manufacture surface layers having high secondary electron emission characteristics without strictly controlling formation atmosphere.

Second, an electron level attributable to Ce is introduced in a forbidden band in the surface layer. By making use of electrons trapped at the electron level attributable to Ce, energy that is obtained in so-called Auger neutralization process and is used for excitation of electrons in the surface layer can be increased during driving of the PDP having the above-mentioned structure. The use of the increased energy promotes significant improvement of secondary electron emission characteristics of the surface layer. Therefore, since discharge can responsively be caused at relatively low firing voltage, the discharge delay can be prevented. Accordingly, it is expected that a PDP capable of delivering excellent image display performance and being driven with low power is realized.

Furthermore, in the surface layer, since the electron level attributable to Ce exists at a certain depth (i.e. a depth energetically not too shallow) from the vacuum level, electrons trapped at the electron level cannot easily be released. As a result, the occurrence of so-called “excessive charge loss” problem is reduced. Here, the “excessive charge loss” is a phenomenon in which an excessive number of electrons are emitted from the surface layer during driving of the PDP. When appropriate charge retention characteristics are exhibited in the surface layer as described above, it becomes possible to emit secondary electrons into a discharge space for a long time.

For the above-mentioned two reasons, the PDP of the present invention has high secondary electron emission characteristics.

Note that the surface layer including (i) a base layer including CeO₂ as the main component and Ba and (ii) a group of MgO particles, which are produced by a gas phase oxidation method, a precursor baking method and the like, disposed on the base layer, can further improve the secondary electron emission characteristics and suppress the discharge delay. Additionally, the surface layer having the above-mentioned structure can improve initial electron emission characteristics during firing. Therefore, even when a PDP having high resolution cells each having a very small discharge space therein is driven at high speed, discharge can be caused by making use of abundant electrons in each discharge space. Additionally, it is expected that display responsiveness is increased, and the problems of discharge delay and temperature dependency of the discharge delay are remedied. As a result, excellent image display performance can be achieved. Furthermore, it becomes possible to stably drive the PDP over wide temperature ranges.

### BRIEF DESCRIPTION OF DRAWINGS

FIG. 1 is a cross-sectional view showing a structure of a PDP pertaining to Embodiment 1 of the present invention.

FIG. 2 is a schematic view showing a relation between electrodes and drivers.

FIG. 3 shows examples of driving waveforms of the PDP.

FIG. 4 is a schematic view showing an electron level unique to CeO₂ and how secondary electrons are emitted in the Auger process.

FIG. 5 is a schematic view showing electron levels in surface layers of the PDP pertaining to Embodiment 1 of the present invention and in a protective film of a conventional PDP, and how secondary electrons are emitted in the Auger process.

FIG. 6 is a cross-sectional view showing a structure of a PDP pertaining to Embodiment 2 of the present invention.

FIG. 7 is a graph showing X-ray diffraction results of samples in which varying concentration of Ba is added to CeO₂.

FIG. 8 is a graph showing dependency of a ratio of carbonate to a surface on Ba concentration in CeO₂, which is obtained through the X-ray diffraction.

FIG. 9 is a graph showing dependency of firing voltage on Ba concentration in CeO₂ when the partial pressure of Xe is 15%.

FIG. 10 is a schematic view showing a general structure of a conventional PDP.

### DESCRIPTION OF EMBODIMENTS

The following describes preferred embodiments and examples of the present invention. Note that the present invention is never limited to these, and various changes may be made as necessary without departing from the technical scope of the present invention.

### Embodiment 1

(Exemplary Structure of the PDP)

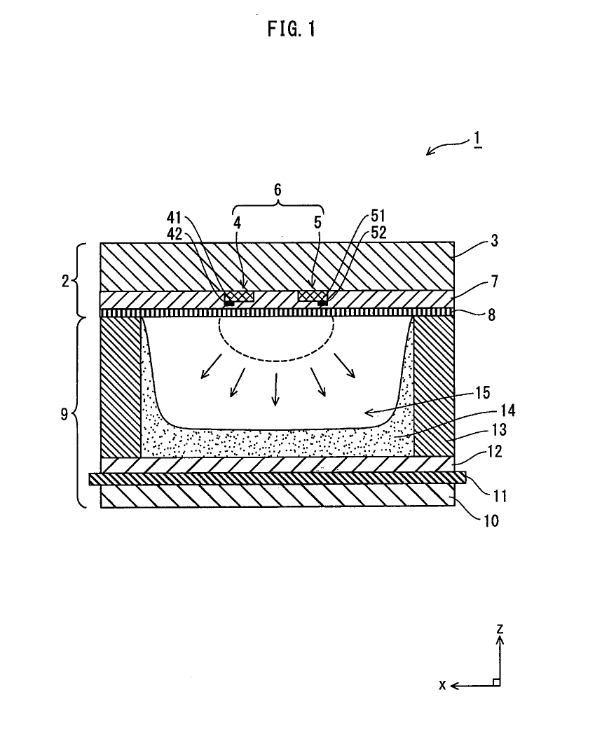

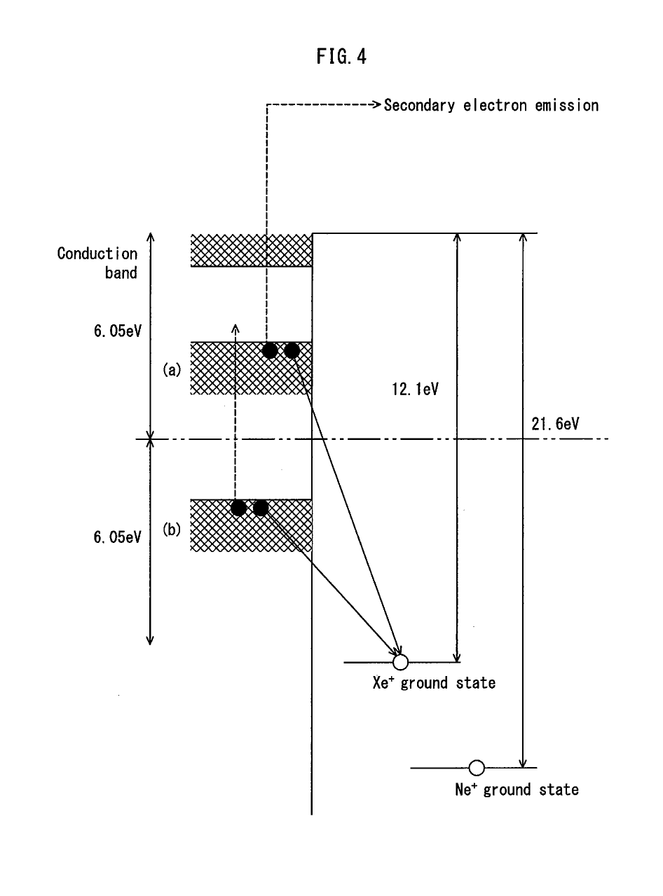

FIG. 1 is a schematic sectional view along an x-z plane of the PDP 1 pertaining to Embodiment 1 of the present invention. The structure of the PDP 1 is similar to the structure (FIG. 4) of a conventional PDP except for the structure in the vicinity of the surface layer 8.

The PDP 1 is an AC type PDP with a 42-inch screen in conformity with the NTSC specification. The present invention may be, of course, applied to other specifications such as XGA and SXGA. The applicable specifications of a high-definition PDP capable of displaying images at an HD (high-definition) resolution or higher are PDPs with a panel size of 37, 42, and 50 inches having 1024×720 (pixels), 1024×768 (pixels), and 1366×768 (pixels), respectively. In addition, a panel with an even higher resolution than these HD panels may also be used. Examples of a PDP having a higher definition than an HD PDP include a full HD PDP with a resolution of 1920×1080 (pixels).

As shown in FIG. 1, the PDP 1 is substantially composed of two members: a first substrate (front panel 2) and a second substrate (back panel 9) that oppose each other in face-to-face relationship.

The front panel 2 includes a front panel glass 3 as its substrate. On one main surface of the front panel glass 3, a plurality of display electrode pairs 6 (each composed of a scan electrode 5 and a sustain electrode 4) are disposed with a given discharge gap (75 μm) in-between. Each display electrode pair 6 is composed of a transparent electrode 51 or 41 and a bus line 52 or 42 layered thereon. Transparent electrodes 51 and 41 (0.1 μm thick, 150 μm wide) are disposed in a stripe made of transparent conductive materials such as indium tin oxide (ITO), zinc oxide (ZnO), and tin oxide (SnO₂). The bus lines 52 and 42 (7 μm thick, 95 μm wide) are made of an Ag thick film (2 μm to 10 μm thick), an Al thin film (0.1 μm to 1 μm thick), a Cr/Cu/Cr layered thin film (0.1 μm to 1 μm thick) or the like. These bus lines 52 and 42 reduce the sheet resistance of the transparent electrodes 51 and 41.

The term “thick film” refers to a film that is formed by various kinds of thick-film forming methods. In thick-film forming methods, a film is formed by applying a paste or the like containing conductive materials and then baking the paste. The term “thin film” refers to a film that is formed by various kinds of thin-film forming methods using vacuum processing such as a sputtering method, ion plating method, or electron-beam deposition method.

On the entire main surface of the front panel glass 3 where the display electrode pairs 6 are disposed, a dielectric layer 7 is formed with use of a screen printing method or the like. The dielectric layer 7 is made of low-melting glass (35 μm thick) that contains lead oxide (PbO), bismuth oxide (Bi₂O₃) or phosphorus oxide (PO₄) as the main component.

The dielectric layer 7 has a current limiting function that is peculiar to the AC type PDP, which is why the AC type PDP can last longer than the DC type PDP.

On one surface of the dielectric layer 7, the surface layer (protective layer) 8 of a film thickness of approximately 1 μm is disposed. The surface layer 8 is applied for the purpose of protecting the dielectric layer 7 from ion bombardment at the time of discharge and lowering the firing voltage. The surface layer 8 is formed with a material that has high sputtering resistance and a high secondary electron emission coefficient γ. The material is required to provide excellent optical transmittance and electrical insulation.

The present invention is characterized mainly by the surface layer 8. The surface layer 8 includes CeO₂ as the main component and Ba. The surface layer as a whole is a crystalline film in which a microcrystalline structure and/or a crystalline structure of NaCl are held. Ba is added to narrow a band gap in the surface layer 8 as will be described later. Due to Ba, effects of reducing an aging time and lowering voltage are produced.

The surface layer 8 may include CeO₂ as the main component and Ba, and have a fluorite structure.

In the present invention, by adding Ba elements to CeO₂, improved secondary electron emission characteristics and charge retention characteristics are exhibited. As a result, stable driving of the PDP 1 with low power becomes possible because of reduced operating voltage (mainly firing voltage and sustain voltage) of the PDP 1.

Note that, when the concentration of Ba is low, secondary electron emission characteristics and charge retention characteristics in the surface layer 8 are not sufficiently exhibited, and a long time is required for aging. For this reason, such concentration is not preferred.

On the other hand, when the concentration of Ba is high, since surface stability of CeO₂ is degraded, secondary electron emission characteristics are not sufficiently exhibited. Additionally, a long time is required for aging to remove contaminants on the surface.

For the above-mentioned reasons, in order to achieve driving with low power and increase optical transmittance, it is important that the concentration of Ba to be added is properly controlled as described above.

When the concentration of Ba is high, since a peak can be observed in a position similar to that of the peak of BaO in thin film X-ray diffraction measurement in which a CuKα-ray is used as a radiation source, it is confirmed that the surface layer 8 has at least an NaCl structure similarly to BaO although the large amount of Ce is included. On the other hand, when the concentration of Ba is low, since a peak can be observed in a position similar to that of the peak of pure CeO₂, it is confirmed that the surface layer 8 has at least a fluorite structure similarly to CeO₂. Since an ionic radius of Ba is very different from an ionic radius of Ce, when the surface layer 8 includes high concentration of Ba (too large amount of Ba is added), the fluorite structure of CeO₂ collapses. However, by properly regulating the concentration of Ba, the crystalline structure (fluorite structure) of the surface layer 8 is maintained.

The back panel 9 includes a back panel glass 10 as its substrate. On one main surface of the back panel glass 10, data electrodes 11 each with a width of 100 μm are formed in a stripe pattern having a fixed gap (360 μm) therebetween. The data electrodes 11 are adjacent to each other in the y direction, and each extends in the x direction longitudinally. The data electrodes 11 are made of any one of an Ag thick film (2 μm to 10 μm thick), an Al thin film (0.1 μm to 1 μm thick), a Cr/Cu/Cr layered thin film (0.1 μm to 1 μm thick), or the like. The dielectric layer 12 with a thickness of 30 μm is disposed on the entire surface of the back panel glass 9 to enclose the data electrodes 11.

On the dielectric layer 12, the grid-shaped barrier ribs 13 (approximately 110 μm high and 40 μm wide) are each disposed above the gap between the adjacent data electrodes 11. The barrier ribs 13 prevent erroneous discharge or optical crosstalk by partitioning the discharge cells.

On the lateral surfaces of two adjacent barrier ribs 13 and on the surface of the dielectric layer 12 between the lateral surfaces, a phosphor layer 14 corresponding to either red (R), green (G) or blue (B) color is formed for color display. Note that the dielectric layer 12 is nonessential and that the phosphor layer 14 may directly cover the data electrodes 11.

The front panel 2 and the back panel 9 are disposed with a space therebetween such that a longitudinal direction of the data electrodes 11 and a longitudinal direction of the display electrode pairs 6 are orthogonal to each other in plan view. The outer peripheral edge portions around the panels 2 and 9 are sealed together with glass frit. In the space between the panels 2 and 9, a discharge gas composed of inert gases such as He, Xe and Ne is enclosed at a given pressure.

Between the barrier ribs 13 is a discharge space 15. Where the adjacent display electrode pairs 6 intersect a data electrode 11 via the discharge space 15 corresponds to a discharge cell (also referred to as a “sub-pixel”) that functions to display images. The discharge cell pitch is 675 μm in the x direction and 300 μm in the y direction. Three adjacent discharge cells whose colors are red, green and blue compose one pixel (675 μm×900 μm).

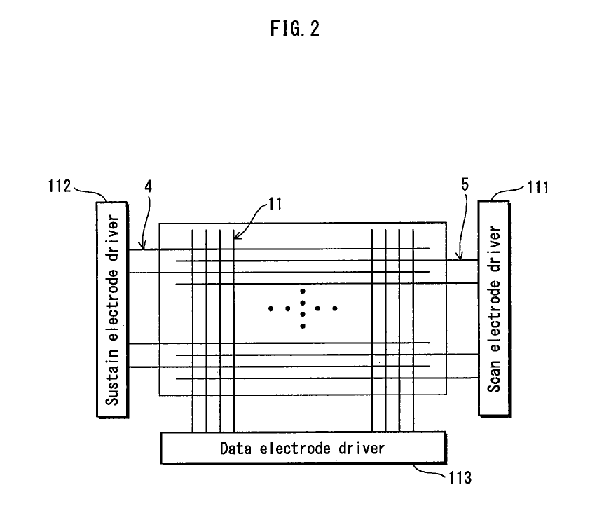

As shown in FIG. 2, the scan electrodes 5, the sustain electrodes 4 and the data electrodes 11 are respectively connected to a scan electrode driver 111, a sustain electrode driver 112 and a data electrode driver 113 that are included in a driving circuit, outside the panel.

(Example of the Driving of the PDP)

As soon as the PDP 1 with the above structure is driven, a heretofore-known driving circuit (not shown) including the drivers 111 to 113 applies an AC voltage ranging from tens to hundreds of kHz between the display electrode pairs 6 to generate discharge in selectable discharge cells. As a result, ultraviolet rays (shown as the dotted line and the arrows in FIG. 1) mainly including resonance lines with wavelengths of mainly 147 nm emitted by the excited Xe atoms and molecular lines with wavelengths of mainly 172 nm emitted by the excited Xe molecules irradiate the phosphor layers 14. Accordingly, the phosphor layers 14 are excited to emit visible light. The visible light then penetrates the front panel 2 and radiates forward.

As an example of the driving, the intra-field time division gradation display method is adopted. This method divides one field of an image into a plurality of subfields (S.F.), and further divides each subfield into a plurality of periods. One subfield is divided into four periods: (1) an initialization period for resetting all the discharge cells to an initial state, (2) a write period for selectively addressing the discharge cells to place the respective discharge cells into a state corresponding to image data input, (3) a sustain period for causing the addressed discharge cells to emit light, and (4) an erase period for erasing wall charges accumulated as a result of the sustain discharge.

In each subfield, the following occurs so that the PDP 1 emits light to display an image. In the initialization period, an initialization pulse resets wall charges in all discharge cells of the entire panel. In the write period, a write discharge is generated in the discharge cells that are intended to light. Subsequently in the sustain period, an AC voltage (sustain voltage) is applied to all the discharge cells simultaneously. Thus, the sustain discharge is generated in the given length of time so as to display the image.

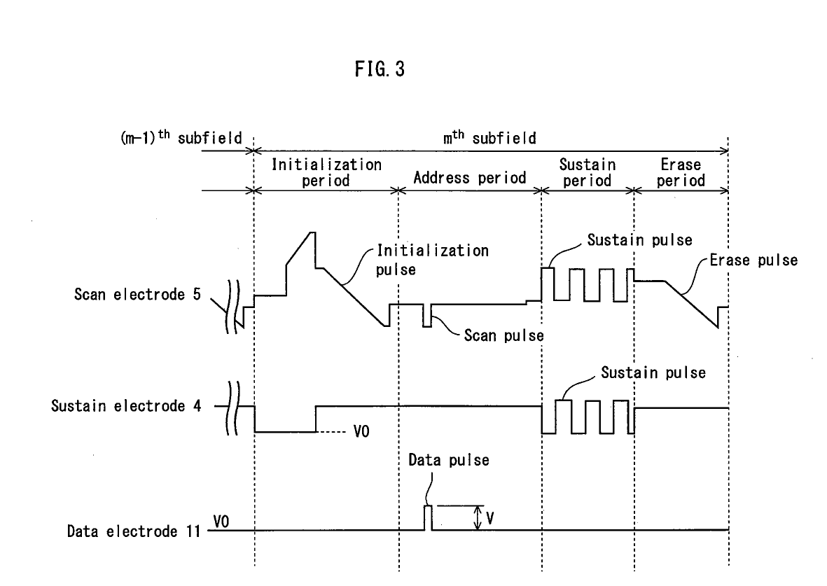

FIG. 3 shows an example of driving waveforms in the m^{th} subfield of one field. As shown in FIG. 3, each subfield is divided into the initialization period, the write period, the sustain period and the erase period.

The initialization period is set for erasing the wall charges in all discharge cells of the entire panel (initialization discharge) so as not to be influenced by the discharge generated prior to the m^{th} subfield (influence of the accumulated wall charges). In the example of the driving waveforms in FIG. 3, a higher voltage (initialization pulse) is applied to the scan electrode 5 than the data electrode 11 and the sustain electrode 4 to cause the gas in the discharge cell to discharge. As a result, electric charges generated by the discharge are accumulated on the wall surface of the discharge cells in order to nullify the potential difference among the data electrodes 11, the scan electrodes 5 and the sustain electrodes 4. Therefore, on the surface of the surface layer 8 around the scan electrodes 5, negative charges are accumulated as wall charges. On the other hand, positive wall charges are accumulated on the surface of the phosphor layers 14 around the data electrodes 11 and on the surfaces of the surface layer 8 around the sustain electrodes 4. These wall charges cause a given value of wall potential between the scan 5 and data 11 electrodes as well as between the scan 5 and sustain 4 electrodes.

The write period is set for addressing the discharge cells that are selected according to image signals divided into subfields (specifying the discharge cells to light or not). In this period, a lower voltage (scan pulse) is applied to the scan electrodes 5 than to the data electrodes 11 or the sustain electrodes 4 in order to light the intended discharge cells. Specifically, a data pulse is applied between the scan 5 and data 11 electrodes in the same polar direction as the wall potential, as well as between the scan 5 and sustain 4 electrodes in the same polar direction as the wall potential, and thus, the write discharge is generated. As a result, negative charges are accumulated on the surface of the phosphor layers 14, on the surface of the surface layer 8 around the sustain electrodes 4, whereas positive charges are accumulated as wall charges on the surface of the surface layer 8 around the scan electrodes 5. Thus, a given value of the wall potential between the sustain 4 and scan 5 electrodes is generated.

The sustain period is set for sustaining the discharge by extending the lighting period of each discharge cell specified by the write discharge so as to keep luminance according to a gradation level. In this period, in the discharge cells that have the wall charges, a voltage pulse for sustain discharge (e.g. a rectangular waveform pulse of approximately 200 V) is applied to each electrode in a pair of a scan electrode 5 and a sustain electrode 4, such that the pulses are out of phase with each other. Thus, a pulse discharge is generated in the addressed discharge cells every time when the polarities reverse at the electrodes.

Due to the sustain discharge, in the discharge space 15, resonance lines having wavelengths of 147 nm are emitted from the excited Xe atoms, and molecular lines of mainly 173 nm are emitted from the excited Xe molecules. Thus, these resonance lines and molecular lines are radiated to the surface of the phosphor layers 14 and converted into visible light, and the image is displayed on the screen. The ON-OFF combinations of the subfields of red, green and blue colors enable an image to be displayed in multiple colors and gradations. Note that in the discharge cells in which the wall charges are not accumulated on the surface layer 8, the sustain discharge is not generated, and the discharge cells display black images.

In the erase period, an erase pulse of a declining waveform is applied to the scan electrodes 5, which erases the wall charges.

(Reduction of Discharge Voltage)

The surface layer 8 includes CeO₂ as the main component and Ba, and has an NaCl structure attributable to BaO. An electron state in an energy band in the surface layer 8 is similar to that in BaO.

Here, an energy level existing as an electron level unique to BaO is at a depth shallower than an electron level unique to MgO from a vacuum level.

Therefore, at the time of driving the PDP 1, an electron existing at the energy level as the electron level unique to BaO transfers to a ground state of an Xe ion. At this time, the amount of energy that is obtained by the Auger effect and acquired by another electron existing at the energy level is larger than that acquired in the case of MgO. The energy acquired by the other electron is sufficient to emit the electron as a secondary electron beyond the vacuum level. As a result, the surface layer 8 exhibits better secondary electron emission characteristics than a surface layer made of MgO.

Specifically, the energy level as the electron level unique to the surface layer in Embodiment 1 is at a level 6.05 eV or less below the vacuum level. On the other hand, the energy level as the electron level unique to MgO is at a level more than 6.05 eV below the vacuum level.

The following describes transition of an electron state during exchange of energy between a discharge gas in the discharge space 15 and the surface layer 8. A reason why the electron level unique to the surface layer 8 is in the above-mentioned area is also described in detail below.

At the time of driving the PDP 1, when an ion attributable to the discharge gas (e.g. Xe ion) is generated in the discharge space 15, and the ion moves close enough to interact with the surface layer 8, an electron existing at an electron level unique to a material constituting the surface layer 8 transfers to a ground state of the ion. At this time, another electron in the surface layer 8 acquires a certain amount of energy obtained by the Auger effect. The amount of energy acquired by the other electron corresponds to an amount of energy obtained by deducting “an amount of energy from the vacuum level to an electron level unique to the material constituting the surface layer 8” from “an amount of energy from the vacuum level to a level where the ion is in a ground state”. By going through the above process, the other electron that acquired the energy jumps an energy gap beyond the vacuum level, and is emitted to the discharge space 15 as a secondary electron.

As shown in FIG. 4, in a band structure, when an Xe ion is in a ground state, the energy level is at a level 12.1 eV below the vacuum level. Therefore, when the energy level unique to the material constituting the surface layer 8 is at a level less than 6.05 eV, which is half of 12.1 eV, below the vacuum level ((a) in FIG. 4), the other electron existing in the surface layer 8 acquires an energy obtained by deducting “an amount of energy from the vacuum level to the electron level unique to the material constituting the surface layer 8” from “an amount of energy from the vacuum level to a level where the Xe atom is in an ionized state (12.1 eV)” (=6.05 eV or more). Consequently, the other electron jumps the energy gap beyond the vacuum level, and is emitted as a secondary electron.

By contrast, when the energy level unique to the material constituting the surface layer 8 is at a level 6.05 eV, which is half of 12.1 eV, or more below the vacuum level ((b) in FIG. 4), even if the other electron acquires an energy obtained by deducting “an amount of energy from the vacuum level to the electron level unique to the material constituting the surface layer 8” from “an amount of energy from the vacuum level to a level where the ion is in a ground state (12.1 eV)” (=less than 6.05 eV), the other electron cannot jump the energy gap beyond the vacuum level. Therefore, the electron cannot be emitted as a secondary electron.

Note that, in general, the sum of a band gap unique to Mg and an electron affinity is approximately 8.8 eV, the sum of a band gap unique to CaO and an electron affinity is approximately 8.0 eV, the sum of a band gap unique to SrO and an electron affinity is approximately 6.9 eV, and the sum of a band gap unique to BaO and an electron affinity is approximately 5.2 eV.

The following describes the mechanism of reduction of discharge voltage in the PDP 1 having the surface layer 8 that includes CeO₂ as the main component and Ba, and has a fluorite structure as a whole.

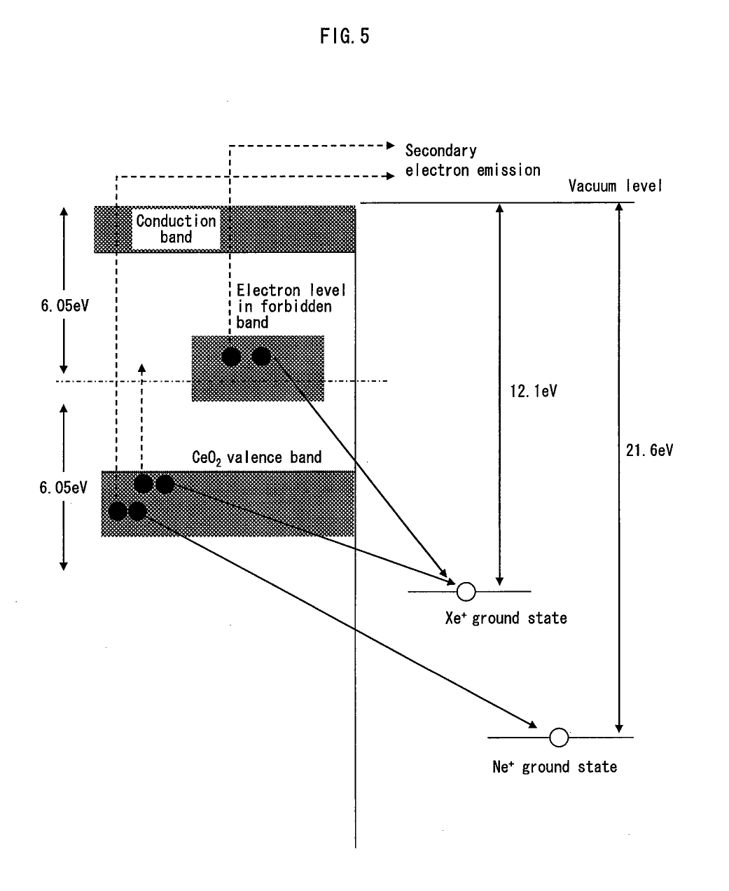

FIG. 5 is a schematic view showing electron levels in the surface layer 8 made of CeO₂.

In the present invention, as a solution to suppress an increase in discharge voltage, an electron level that is more susceptible to the Auger effect is introduced in a forbidden band at a depth relatively shallow from the vacuum level of CeO₂ as shown in FIG. 5. The electron level is introduced by adding Ba to the surface layer 8 at an amount that can maintain a fluorite structure. In the present invention, by introducing such an electron level, an energy that is obtained in the Auger neutralization process to emit secondary electrons is increased. Therefore, usable energy in the energy used for excitation of electrons in the surface layer can be increased. Accordingly, the probability of emitting secondary electrons increases in the present invention. As a result, abundant secondary electrons can be used in the discharge space 15. Therefore, since operating voltage in the PDP 1 is reduced, and discharge can be generated on a large scale, a PDP delivering excellent image display performance can be driven with low power.

### Embodiment 2

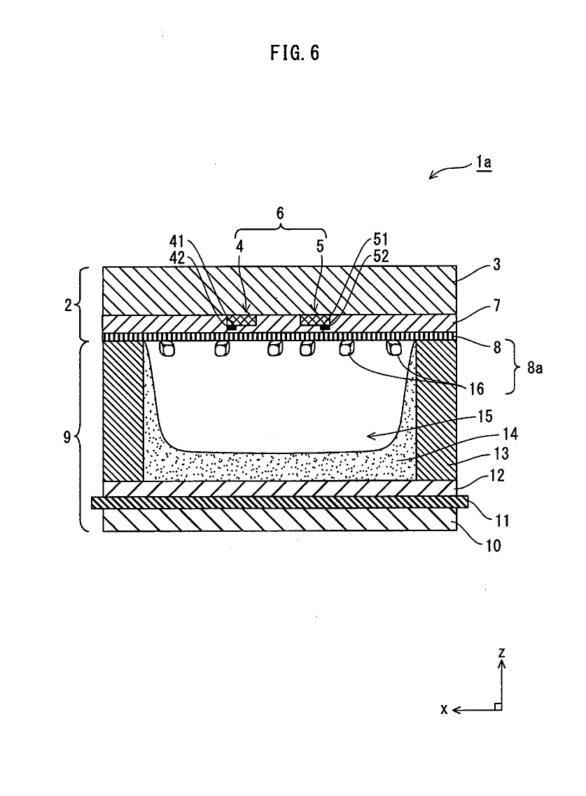

The following is a description of Embodiment 2 of the present invention, focusing on the differences with Embodiment 1. FIG. 6 is a cross-sectional view showing a structure of the PDP 1a pertaining to Embodiment 2.

Although having a similar basic structure to the PDP 1, the PDP 1a is characterized by having a surface layer 8a composed of (i) the surface layer 8 as a base layer 8 and (ii) MgO particles 16 having high initial electron emission characteristics and being dispersed on the surface of the surface layer 8. The density of the MgO particles 16 is determined, for example, such that the base layer 8 cannot be seen directly when the surface layer 8a in a discharge cell 2d is viewed along a Z direction. The density, however, is not limited to this. For example, the MgO particles 16 may be disposed on parts of the surface of the base layer 8. More specifically, the MgO particles 16 may be disposed on parts of the surface under which the display electrode pairs 6 are disposed.

Note that, in FIG. 6, sizes of the MgO particles 16 disposed on the base layer 8 are enlarged compared with the actual size in order to schematically show the structure of the PDP 1a. The MgO particles 16 may be produced by either a gas phase method or a precursor baking method. However, it was established by the inventors of the present application that the MgO particles 16 having good performance can be produced by the precursor baking method (described later).

In the PDP 1a having the above-mentioned structure, characteristics of the base layer 8 and the MgO particles 16, which are functionally separated with each other, can be synergistically exhibited in the surface layer.

Specifically, as in the case of PDP 1, secondary electron emission characteristics are improved during driving due to the base layer 8 in which Ba is added to CeO₂. As a result, operating voltage is reduced, and the PDP 1a can be driven with low power. Additionally, since the base layer 8 has excellent charge retention characteristics, the secondary electron emission characteristics can be stably exhibited for a long time even when the PDP 1a is continuously driven.

At the same time, in the PDP 1a, the initial electron emission characteristics are improved because of the MgO particles 16. Due to the improved initial electron emission characteristics, discharge responsiveness is dramatically improved, and thus the problems of the discharge delay and the temperature dependency of the discharge delay are expected to be reduced. This effect is particularly striking when the present invention is applied to a high-definition PDP and the high-definition PDP is driven at high speed using a narrowed pulse. In this case, excellent image display performance is delivered.

Note that, in the PDP 1a, since the surface of the base layer 8 is protected by the MgO particles 16, a problem of impurities that are included in the discharge space 15 and directly adhere to the surface of the base layer 8 can be reduced. This is expected to further improve life characteristics of the PDP.

(MgO Particles 16)

Through experiments conducted by the inventors of the present application, it was confirmed that the MgO particles 16 disposed on the PDP 1a mainly have an effect of suppressing the “discharge delay” caused in the write discharge and improving the temperature dependency of the “discharge delay”. Consequently, in the PDP 1a in Embodiment 2, the MgO particles 16 are disposed to face the discharge space 15 as elements that emit initial electrons during driving, by making use of the fact that the MgO particles 16 have higher initial electron emission characteristics than the base layer 8.

The “discharge delay” is considered to be caused mainly by the shortage of initial electrons, which are triggers, being emitted from the surface of the base layer 8 into the discharge space 15 during firing. In order to effectively emit initial electrons into the discharge space 15, the MgO particles 16 that emit an extremely larger number of initial electrons than the base layer 8 are dispersed on the surface of the base layer 8. With this structure, a large number of initial electrons needed in the address period are emitted from the MgO particles 16, and thus an attempt is made to solve the problem of the discharge delay. By improving the initial electron emission characteristics in this manner, the PDP 1a can be responsively driven at high speed even when the PDP 1a is a high-definition PDP.

Furthermore, with the structure in which the MgO particles 16 are disposed on the surface of the base layer as described above, it was found that the effect of improving the temperature dependency of the “discharge delay” can be achieved along with the effect of suppressing the “discharge delay”.

As set forth above, in the PDP 1a, the surface layer is composed of (i) the base layer 8 that enables driving of the PDP 1a with low power, and has secondary electron emission characteristics and charge retention characteristics and (ii) the MgO particles 16 having an effect of suppressing the discharge delay and the temperature dependency of the discharge delay. With this structure, the PDP 1 as a whole can be driven at high speed with low power even when the PDP 1 has high resolution discharge cells, and high-quality image display performance is expected to be achieved by inhibiting lighting failures in cells.

Furthermore, since the MgO particles 16 are dispersed on the surface of the base layer 8, the MgO particles 16 have a consistent effect of protecting the base layer 8. While the base layer 8 has a high secondary electron emission coefficient and enables a PDP to be driven with low power, the surface layer 8 has relatively high adsorption properties with respect to impurities such as water, carbon dioxide, and hydrocarbon. Once impurities are adsorbed, initial characteristics of the discharge such as the secondary electron emission characteristics are compromised. By covering the base layer 8 with the MgO particles 16 in the above-mentioned manner, adsorption of impurities to the surface of the base layer 8 from the discharge space 15 can be prevented in an area covered with the MgO particles 16. Therefore, the life characteristics of the PDP 1a can be expected to be improved.

PDP Manufacturing Method

The following describes an exemplary manufacturing method for the PDPs 1 and 1a in Embodiments 1 and 2 respectively. The only substantial difference between the PDPs 1 and 1a is the structure of the surface layers 8 and 8a. The manufacturing process for other parts is identical.

(Manufacturing of the Back Panel)

On a surface of the back panel glass 10 made of soda-lime glass with a thickness of approximately 2.6 mm, conductive materials mainly containing Ag are applied with the screen printing method in a stripe pattern at a given interval. Thus, the data electrodes 11 with a thickness of some μm (e.g. approximately 5 μm) are formed. The data electrodes 11 are made of a metal such as Ag, Al, Ni, Pt, Cr, Cu, and Pd or a conductive ceramic such as metal carbide and metal nitride. The data electrodes 11 may be made of a composition of these materials, or may have a layered structure of these materials as necessary.

The gap between two adjacent data electrodes 11 is set to approximately 0.4 mm or less so that the PDP 1 has a 40-inch screen in conformity with the NTSC or VGA specification.

Next, a glass paste with a thickness of approximately 20 to 30 μm made of lead-based or lead-free low-melting glass or SiO₂ material is applied and baked over the back panel glass 10 on which the data electrodes 11 are formed in order to form the dielectric layer.

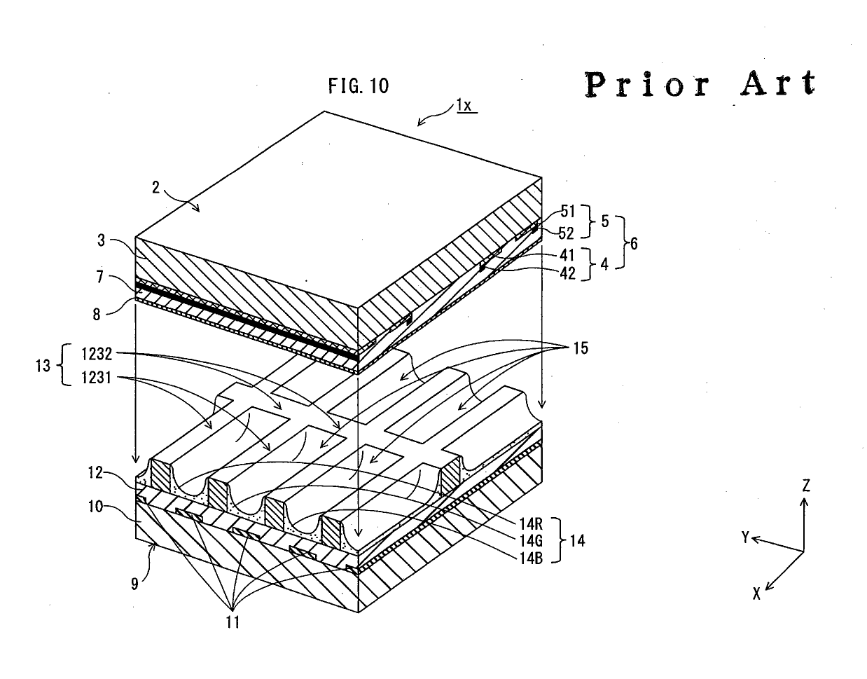

Subsequently, the barrier ribs 13 are formed in a predetermined pattern on a surface of the dielectric layer 12. The barrier ribs 13 are formed by applying a low-melting glass paste, and using a sandblast method or a photolithography method to form a grid pattern (see, FIG. 10) dividing the arrays of discharge cells into rows and columns, so as to form borders between adjacent discharge cells (not illustrated).

After the barrier ribs 13 are formed, on the lateral surfaces of the barrier ribs 13 and on the surface of the dielectric layer 12 exposed between the barrier ribs 13, phosphor ink containing one of red (R), green (G), and blue (B) phosphors that are normally used for the AC type PDP is applied. Then, the phosphor ink is dried and baked to form each phosphor layer 14.

The following compositions can be applied in each of the RGB phosphors.

Red phosphor; (Y, Gd)BO₃:Eu

Green phosphor; Zn₂SiO₄:Mn

Blue phosphor; BaMgAl₁₀O₁₇:Eu

As for a form of each phospher material, powders with a mean particle diameter of 2.0 μm are preferred. The phosphor material, ethylcellulose, and solvent (α-terpineol) are injected into a server at 50 percent by mass, 1.0 percent by mass, and 49 percent by mass, respectively, and mixed in a sand mill to manufacture a phosphor ink with a viscosity of 15×10⁻³ Pa·s. This phosphor ink is sprayed by a pump through a nozzle that has a diameter of 60 μm to apply the ink between adjacent barrier ribs 13. At that time, the panel is moved in the longitudinal direction of the barrier ribs 20. Accordingly, the ink is applied in a stripe pattern on the panel. After application is completed, the phosphor ink is baked for 10 minutes at 500° C. to form the phosphor layer 14.

The back panel 9 is completed in the above-mentioned manner.

Although, in the above-mentioned method, the front panel glass 3 and the back panel grass 10 are made of soda-lime glass, the soda-lime glass is just an example of the material. The front and back panel glasses may be made of another material.

(Manufacturing of the Front Panel 2)

On the surface of the front panel glass 3 made of soda-lime glass with a thickness of approximately 2.6 mm, the display electrode pairs 6 are formed. The printing method is shown here as an example to form the display electrode pairs 6. The display electrode pairs 6, however, may be formed by a die coat method, blade coat method, or the like.

To begin with, on the front panel glass 3, transparent electrode materials such as ITO, SnO₂, and ZnO are applied in a given pattern such as a stripe pattern and dried. Thus, transparent electrodes 41 and 51 with a final thickness of approximately 100 nm are formed.

Meanwhile, a photosensitive paste is prepared by blending Ag powder and an organic vehicle with a photosensitive resin (photodegradable resin). The photosensitive paste is applied on the transparent electrodes 41 and 51, and the transparent electrodes 41 and 51 are covered with a mask having a pattern of the display electrode pairs. After an exposure process on the mask and a development process, the photosensitive paste is baked at a baking temperature of approximately 590° C. to 600° C. Thus, the bus lines 42 and 52 with a final thickness of some μm are formed on the transparent electrodes 41 and 51. Though the screen method can conventionally produce a bus line with a width of 100 μm at best, this photomask method enables the bus lines 42 and 52 to be formed as small as 30 μm. Besides Ag, the bus lines 42 and 52 can be made of other metal materials such as Pt, Au, Al, Ni, Cr, tin oxide and indium oxide. Other than the above methods, the bus lines 42 and 52 can be formed, after forming a film made of electrode materials by the deposition method or the sputtering method, by etching the film.

Subsequently, a paste is prepared by blending (i) lead-based or lead-free low-melting glass with a softening point of 550° C. to 600° C. or SiO₂ powder with (ii) organic binder such as butyl carbitol acetate. The paste is applied on the formed display electrode pairs 6, and baked at a temperature ranging from 550° C. to 650° C. Thus, the dielectric layer 7 with a final thickness of some μm to some tens of μm is formed.

(Formation of the Surface Layer)

The following describes steps for forming the surface layers of the PDPs 1 in Embodiment 1 and 1a in Embodiment 2.

At first, a case where the surface layer (base layer) 8 is formed by the electron-beam deposition method is described.

First, a pellet as an evaporation source is prepared. The pellet is manufactured in the following manner. CeO₂ powder is mixed with BaCO₃ powder, which is a carbonate of an alkaline-earth metal. The mixture is deposited in a metal mold, and molded by applying pressure. Then, the molded mixture is placed in an alumina crucible, and baked for 30 minutes at approximately 1400° C. to obtain a sintered body, namely, the pellet.

The sintered body, or the pellet, is placed in a deposition crucible in an electron-beam deposition apparatus. By depositing the pellet on the surface of the dielectric layer 7 as the evaporation source, the surface layer 8 including CeO₂ and Ba is formed. The concentration of strontium is adjusted, by controlling a ratio of CeO₂ to strontium carbonate, in the stage of obtaining the mixture to be placed in the alumina crucible. The surface layer of the PDP 1 is completed after having gone through the above processes.

Besides the electron-beam deposition method, a known method such as, a sputtering method, an ion plating method, or the like can be used to form the surface layer (base layer) 8.

Next, the MgO particles 16 are prepared when the PDP 1a is manufactured. The MgO particles 16 can be prepared by either the gas-phase synthesis method or the precursor baking method described below.

(Gas-Phase Synthesis Method)

A magnesium metal material (99.9% pure) is heated in an atmosphere filled with an inert gas. While maintaining the heating, a small amount of oxygen is introduced to the inert gas atmosphere, and the magnesium is directly oxidized, thus creating the MgO particles 16.

(Precursor Baking Method)

Any of the below-listed MgO precursors are baked evenly at a high temperature (e.g., 700° C. or higher) and then cooled, thereby obtaining MgO particles 16. The MgO precursor can be any one or more (or a mixture of two or more) selected from the group consisting of, for example, magnesium alkoxide (Mg(OR)₂), mangensium acetylacetone (Mg(acac)₂), magnesium hydroxide (Mg(OH)₂), MgCO₃, magnesium chloride (MgCl₂), magnesium sulfate (MgSO₄), magnesium nitrate (Mg(NO₃)₂), and magnesium oxalate (MgC₂O₄). Note that some of the above compounds may normally be in hydrate form. These compounds in hydrate form may also be used.

The magnesium compound selected as the MgO precursor is adjusted so that MgO obtained after baking has a purity of 99.95% or more, or more preferably 99.98% or more. This is because of the fact that if a certain amount or more of an impurity element such as an alkali metal, B, Si, Fe, or Al is included in the magnesium compound, unnecessary adhesion and sintering occurs during heat processing, thereby making it difficult to obtain highly crystalline MgO particles 16. For this reason, the precursor is adjusted in advanced by removing impurity elements.

The MgO particles 16 obtained by either of the above methods are dispersed in a solvent. The dispersion liquid is then dispersed on the surface of the completed base layer 8 by a spray method, a screen printing method, or an electrostatic application method. Thereafter drying and baking are performed to eliminate the solvent, and the MgO particles 16 are thus attached to the surface of the base layer 8.

The surface layer 8a of the PDP 1a is formed in the above-mentioned manner.

(Completion of the PDP)

The manufactured front panel 2 and back panel 9 are sealed together at opposing edge portions thereof with the use of sealing glass. Thereafter, the discharge space 15 is evacuated to a high vacuum (approximately 1.0×10⁻⁴ Pa), and an Ne—Xe based, He—Ne—Xe based, Ne—Xe—Ar based discharge gas or the like is enclosed in the discharge space 15 at a predetermined pressure (here, 66.5 kPa to 101 kPa).

The PDPs 1 and 1a are completed after having gone through the above processes.

### (Performance Confirmation Experiments)

Next, in order to confirm performance of the present invention, the following PDP samples 1 to 8 were prepared.

The basic structures of these PDP samples are the same. The structures of the surface layers in these PDP samples are, however, different with one another.

As a way of expressing the amount of Ba included in the surface layer (base layer) that includes CeO₂ as the main component, Ba/(Ba+Ce)*100 (hereinafter, described as “X_{Ba}”) is used. This indicates a ratio of the number of Ba atoms to the total number of Ce and Ba atoms.

Note that, although a unit of X_{Ba} can be represented by both (%) and (mol %), hereinafter (mol %) is used for the sake of convenience.

Since sample 1 (comparative example 1) has the most basic structure of the conventional PDP, the sample 1 has a surface layer made of MgO formed by the EB deposition method (Ce and Ba are not included).

The samples 2 and 7 (comparative examples 2 to 4) have surface layers made by adding Ba to CeO₂. X_{Ba}s of the surface layers included in the samples 2, 3, and 7 are 0 mol %, 9.3 mol %, and 100 mol %, respectively.

The samples 4 to 6 (working examples 1 to 3) correspond to the structure of the PDP 1 in Embodiment 1, and have surface layers made by adding Ba to CeO₂. X_{Ba}s of the surface layers included in the samples 4 to 6 are 16.4 mol %, 23.8 mol %, and 31.2 mol %, respectively.

The sample 8 (working example 4) corresponds to the structure of the PDP 1a in Embodiment 2, and has the surface layer including (i) a base layer that is made by adding Ba to CeO₂ such that X_{Ba} is 31.2 mol % and (ii) the MgO particles that are produced by the precursor baking method and dispersed on the base layer.

The structures of the surface layers in the samples 1 to 8 and experimental data obtained by using these samples are shown in the following Table 1.

TABLE 1

| | Film Ba | | | Ratio of | Discharge | | |
|---|---|---|---|---|---|---|---|
| | concentration, X_{Ba} | Film | MgO | carbonate | voltage (v) (Xe15% | Aging time | Discharge |
| | Ba/(Ba + Ce) * 100 (%) | state | particles | (%) | 450 torr) | (time) | delay* |
| Sample 1 (Comparative Example 1) | — | MgO | Not disposed | | | 30 | Δ |
| Sample 2 (Comparative Example 2) | 0.0 | CeO₂ | Not disposed | 21.2 | 247 | 240 | X |
| Sample 3 (Comparative Example 3) | 9.3 | CeO₂ | Not disposed | 32.0 | 239 | 120 | Δ |
| Sample 4 (Working Example 1) | 16.4 | CeO₂ | Not disposed | 49.2 | 236 | 60 | Δ |
| Sample 5 (Working Example 2) | 23.8 | CeO₂ | Not disposed | 54.3 | 236 | 30 | Δ |
| Sample 6 (Working Example 3) | 31.2 | BaO | Not disposed | 57.4 | 209 | 30 | Δ |
| Sample 7 (Comparative Example 4) | 100.0 | Ba(OH)₂ + | Not disposed | 86.9 | 290 | Not finished | Δ |
| | | BaCO₃ | | | | within 7 h | |
| Sample 8 (Working Example 4) | 31.2 | BaO | Disposed | — | 210 | 30 | ◯ |

*“◯” indicates that an effect of reducing discharge delay is favorable, “Δ” indicates that the effect is less favorable than that shown in “◯”, and “X” indicates that the effect is not shown.

[Experiment 1] Film Property Evaluation (Crystalline Structure Analysis)

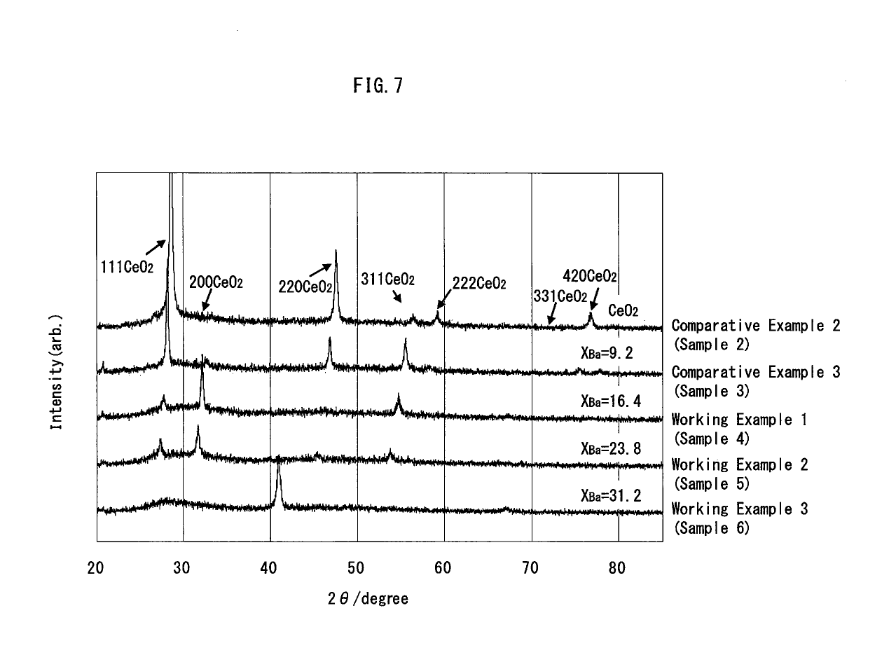

In order to examine crystalline structures of the above-mentioned samples, θ/2θ X-ray diffraction measurement was carried out. FIG. 7 shows results of the measurement, and Table 1 shows the analysis results thereof. FIG. 7 shows profiles of the samples 2, 3, 4, 5, and 6 that have surface layers whose X_{Ba}s are 0 mol %, 9.3 mol %, 16.4 mol %, 23.8 mol %, and 31.2 mol %, respectively.

In the samples 2 to 5 that have surface layers whose X_{Ba}s are 0 mol %, 9.3 mol %, 16.4 mol %, and 23.8 mol %, respectively, the existence of only CeO₂ having a fluorite structure was confirmed.

On the other hand, in the sample 6 that has the surface layer whose X_{Ba} reaches approximately 31.2 mol % and includes a large amount of Ba, a single phase of BaO was detected.

The surface layer that is made of BaO and does not include Ce is easily hydroxylated and carbonized as soon as it is exposed to the air. When the X-ray diffraction measurement is carried out, a phase indicating that it is hydroxylated and carbonized is identified, but a phase of BaO is not identified. However, when an oxide is generated by properly controlling a ratio between Ba and Ce, the layer including BaO as the main component, which is highly stable, can be generated.

(Surface Stability Evaluation)

In general, when a large amount of carbonate is included in the surface layer, secondary electron emission characteristics inherent to the surface layer cannot be exhibited, resulting in an increase in operating voltage. In order to prevent the large amount of carbonate from being included in the surface layer, an aging process is necessary. In the aging process, PDPs are discharged for a certain period of time before being shipped to market to remove contaminant on the surface layer. Given the productivity of PDP manufacturing, it is desired that the aging process is finished in a short time. Therefore, it is preferred that carbonate in the surface layer is removed as much as possible before the aging process.

The stability of the surface of the protective film was examined in each sample including a protective layer that is made of MgO and includes carbonate as an impurity. In the examination, the amount of carbonate included in the surface of the protective film was measured based on X-ray photoelectron spectroscopy (XPS). The protective film in each sample is exposed to the air for a certain period of time after formation, placed on a plate for measurement, and then injected into an XPS measurement chamber. Since the surface of the surface layer is expected to be carbonized during the exposure to the air, the time required for the exposure to the air is set for 5 minutes so that the samples are processed under the same conditions.

“QUANTERA” manufactured by ULVAC-PHI was used as an XPS measurement device. Al—Kα was used as an X-ray source, and a monochromator was used. Insulating experiment samples were neutralized by using a neutralizing gun and an ion gun. In the experiment, energy in regions corresponding to Mg2p, Ce3d, C1s, and O1s are measured through 30 cycles of estimation. From a peak area of a spectrum obtained in the measurement and a sensitivity coefficient, elemental composition of the surface of the surface layer is derived. Waveform separation of a C1s spectral peak into a spectral peak detected in the vicinity of 290 eV and a spectral peak of C and CH detected in the vicinity of 285 eV is performed, and a ratio of each of the spectral peaks is obtained. Then, the amount of CO in the surface of the surface layer is obtained from the product of C composition and a ratio of CO to the C composition. By using the amounts of CO in the surfaces of the surface layers in the samples obtained by the XPS, stabilities of the surfaces of the surface layers, namely, degrees of carbonation are compared.

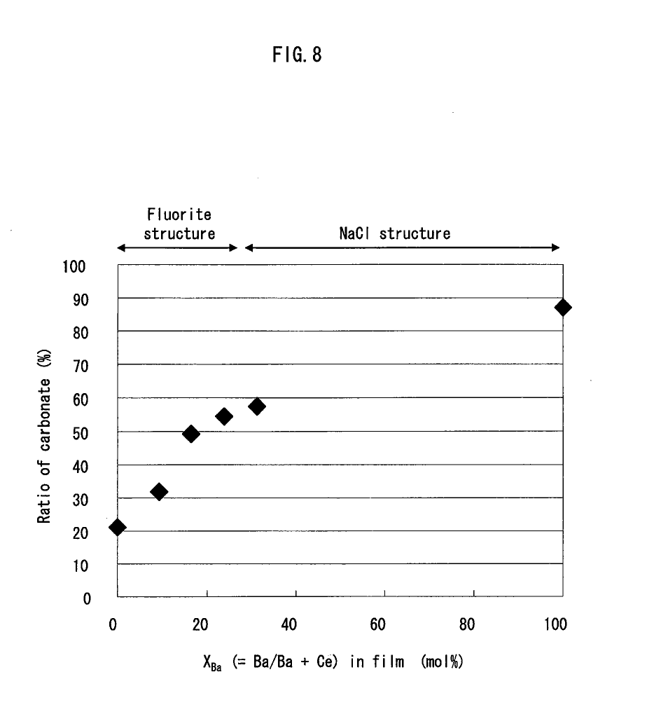

The XPS measurement was carried out under the above-mentioned conditions. FIG. 8 is a graph in which ratios of carbonate to the surface are plotted.

Measured points in FIG. 8 show that the ratio of carbonate increases in proportion to the amount of added Ba. From the result, in order to prevent the surface of the film from being contaminated by carbonate, it is desired that the amount of Ba in the film be reduced as much as possible.

Additionally, in working examples 1 and 2 shown in Table 1, the ratio of carbonate was relatively low and excellent results were produced. In view of these results, an advantageous effect of reducing carbonate is expected to be obtained by constituting the surface layer such that X_{Ba} is at least in a range of 16 mol % to 24 mol % inclusive.

[Experiment 2] Discharge Characteristics Evaluation (Discharge Voltage)

In order to examine characteristics of operating voltage in the above samples, the PDP samples were produced by using Xe—Ne mixed gas with the Xe partial pressure of 15% as a discharge gas, and sustain voltage of the PDP samples were measured.

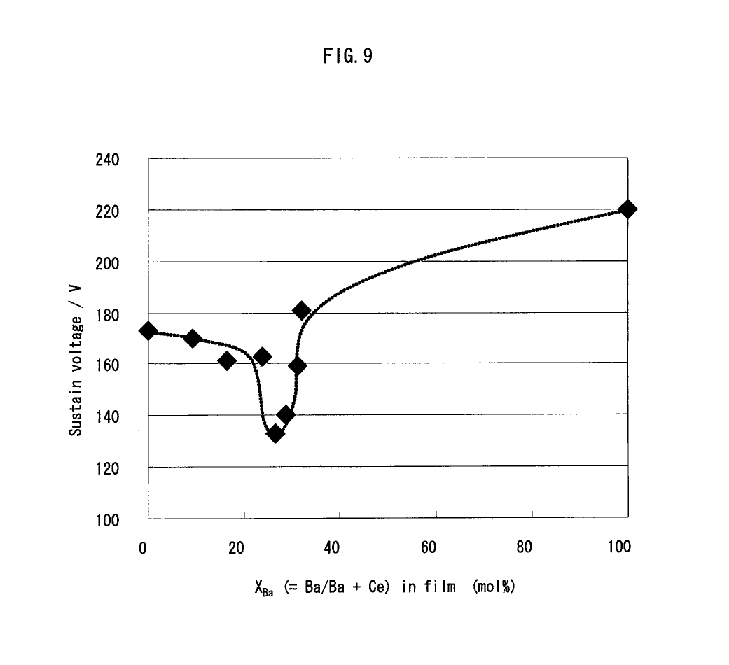

FIG. 9 is a graph in which values of firing voltage for X_{Ba}s of the surface layers measured under the above-mentioned conditions are plotted.

As shown in FIG. 9 and Table 1, when X_{Ba} is in a range of 16 mol % to 31 mol % (a range substantially corresponding to working examples 1 to 3) inclusive, since sustain voltage is reduced from approximately 175 V to 140 V or less, it was confirmed that the driving of a PDP with low power is promoted. Furthermore, when X_{Ba} is in a range of 26 mol % to 29 mol % (a range approximately corresponding to working examples 2 and 3) inclusive, since discharge voltage is reduced to approximately 130 V, it is found that the driving of a PDP with low power can be further promoted.

This is thought to be because, by adding Ba, a level of the valence band in the surface layer is elevated. As a result, secondary electron emission characteristics are improved.

On the contrary, when X_{Ba} considerably exceeds 31 mol %, it was confirmed that discharge voltage is increased (comparative example 4). This is thought to be because the surface comes to have a structure in which BaO is included as the main component, and the surface layer is contaminated in a process of manufacturing a panel.

These results show that too large amount of Ba included in the surface layer is undesirable, and there is an adequate concentration range.

(Measurement of Discharge Delay)

Next, by using the same discharge gas as the above-mentioned discharge gas, degrees of discharge delay in the write discharge were evaluated in a sample that has the surface layer including a protective film and MgO particles disposed on the protective film. The evaluation method involved applying a pulse corresponding to an initialization pulse in the exemplary drive waveform shown in FIG. 3 to one arbitrary cell in each of the PDP samples 1 to 8, and thereafter measuring a statistical delay in discharge when a data pulse and scan pulse are applied.

As a result, it was found that, in the sample 8 (working example 4) that has the surface layer on which MgO particles are disposed, the occurrence of the discharge delay is effectively reduced compared with the other samples 2 to 7.

As described above, an effect of preventing discharge delay in a PDP is further improved by disposing MgO particles on the protective film. Note that the MgO particles produced by the precursor baking method are more effective than the MgO particles produced by the gas phase method. Accordingly, the precursor baking method is a method of producing MgO particles suitable for the present invention.

As shown by the experimental data of the sample 8 (working example 4), by constructing the surface layer composed of (i) the surface layer having a predetermined Ba concentration and (ii) the MgO particles disposed on the surface layer, a PDP that can be driven with low power and rarely cause the discharge delay can be obtained.

### INDUSTRIAL APPLICABILITY

The PDP of the present invention can be used in, for example, gas discharge panels that are driven at low voltage and display high definition images. In addition, the PDP of the present invention is also applicable to information display apparatuses in transportation facilities and public facilities, television apparatuses or computer displays in homes and offices.

### REFERENCE SIGNS LIST

1, 1x PDP

2 front panel

3 front panel glass

4 sustain electrode

5 scan electrode

6 display electrode pairs

7, 12 dielectric layer

8, 8a surface layer (high γ film)

9 back panel

10 back panel glass

11 data (address) electrode

13 barrier ribs

14, 14R, 14G, 14B phosphor layer

15 discharge space

16 MgO particles

1. A plasma display panel having a first substrate and a second substrate that oppose each other and are sealed together at opposing edge portions thereof so as to enclose a discharge space, the first substrate including a plurality of display electrode pairs, the discharge space being filled with a discharge gas, wherein
the first substrate includes a surface layer at a side thereof facing the discharge space, the surface layer including CeO₂ as a main component and Ba, a concentration of Ba in the surface layer being in a range of 16 mol % to 31 mol % inclusive.

2. The plasma display panel of claim 1, wherein
the concentration of Ba in the surface layer is in a range of 16 mol % to 24 mol % inclusive.

3. The plasma display panel of claim 1, wherein
the concentration of Ba in the surface layer is in a range of 26 mol % to 29 mol % inclusive.

4. The plasma display panel of claim 2, wherein
the surface layer has a fluorite structure.

5. The plasma display panel of claim 1, wherein
the first substrate includes MgO particles disposed on the surface layer so as to face the discharge space.
